(19) United States
(12) Patent Application Publication
(10) Pub. No.: US 2023/0043816 A1
(43) Pub. Date: Feb. 9, 2023

(54) METHODS FOR AN ENHANCED PAGING OF A WIRELESS DEVICE OF A SET OF WIRELESS DEVICES, RELATED NETWORK NODES AND WIRELESS DEVICES

(71) Applicant: Sony Group Corporation, Tokyo (JP)

(72) Inventors: Nafiseh MAZLOUM, Lund (SE); Fredrik RUSEK, Eslov (SE); Jose FLORDELIS, Lund (SE); Johan HILL, Lund (SE)

(21) Appl. No.: 17/791,892

(22) PCT Filed: Jan. 13, 2021
(86) PCT No.: PCT/EP2021/050512

§ 371 Date: Jul. 9, 2022

(30) Foreign Application Priority Data
Jan. 28, 2020 (SE) 2050077-3

(51) Int. Cl. H04W 68/00; H04W 52/02

(52) U.S. Cl. CPC H04W 68/005; H04W 52/0229; H04W 52/0216

(57) ABSTRACT

Disclosed is a method performed by a network node, for an enhanced paging of a wireless device of a set of wireless devices. The method comprises controlling transmission, to the set of wireless devices, of a first paging message in a first paging period. The method comprises transmitting, to the set of wireless devices, in at least one physical signal between the first paging period and a second paging period succeeding the first paging period, control signaling indicating a change in paging of the second paging period, wherein the change in paging is with respect to the first paging period. The method comprises controlling, in accordance with the indicated change, transmission, to the set of wireless devices, of a second paging message in the second paging period.

The present disclosure pertains to the field of wireless communications. The present disclosure relates to methods for an enhanced paging of a wireless device of a set of wireless devices, related network nodes and wireless devices.

### BACKGROUND

To save power, a wireless device (such as a user equipment, UE) can go to idle mode whenever it has no data to be transmitted. During idle mode, the wireless device is requested to periodically monitor for paging information—at a rate referred to as discontinuous reception, or more commonly, a discontinuous reception, DRX, cycle. In New Radio, NR, Frequency Range FR2, the burden of monitoring paging is, however, dramatically increased compared with FR1 and Long Term Evolution, LTE.

Indeed, the wireless device is, prior to reading the paging information, to establish which beam to use for reception, and which gNB transmit beam to listen to. In fact, the wireless device may not even be aware of which of its antenna arrays that should be used for reception; a typical DRX cycle is e.g. 2-3 seconds, but in future this can be as long as hours, and it is not unlikely that the wireless device has been rotated/moved, so that an entirely different antenna array is to be used compared with the one used during the most recent paging occasion.

### SUMMARY

In NR FR2, the wireless device is to wake up much earlier than the paging occasion in order to establish a suitable beam to be used during the paging occasion. To establish the beam, the wireless device needs to listen to the synchronization signal block, SSB, bursts that precede the paging occasion. The SSB bursts have a typical periodicity of 20 ms, so an additional time awake of 100 ms is not unrealistic (to monitor all the wireless device's panels). The additional awake time of the wireless device increases the power consumption of the wireless device.

Accordingly, there is a need for devices and methods for an enhanced paging of a wireless device of a set of wireless devices which mitigate, alleviate or address the existing shortcomings and provide paging of a wireless device which is energy-efficient. It may be appreciated that there is a need for an enhanced paging of a wireless device of a set of wireless devices which is time-efficient, and allows a reduction of the power consumption of the wireless device related to paging.

Disclosed is a method performed by a network node, for an enhanced paging of a wireless device of a set of wireless devices. The method comprises controlling transmission, to the set of wireless devices, of a first paging message in a first paging period. The method comprises transmitting, to the set of wireless devices, in at least one physical signal between the first paging period and a second paging period succeeding the first paging period, control signalling indicative of a change in paging of the second paging period, wherein the change in paging is with respect to the first paging period. The method comprises controlling, in accordance with the indicated change, transmission, to the set of wireless devices, of a second paging message in the second paging period.

Further, a network node is provided, the network node comprising: a memory circuitry, a processor circuitry, and a wireless interface, wherein the network node is configured to perform any of the methods disclosed herein.

It is an advantage of the present disclosure that the disclosed network node and disclosed method allow the wireless device to reduce awake time and to avoid false-wake-up or overhearing energy cost as well as cost associated with idle-channel listening, especially for the wireless devices in multi-beam operation.

Disclosed is a method performed by a wireless device, for an enhanced paging of the wireless device. The method comprises receiving, from the network node, in at least one physical signal between a first paging period and a second paging period succeeding the first paging period, control signalling indicating a change in a paging of the second paging period, wherein the change is with respect to the first paging period. The method comprises monitoring the second paging period based on the received control signalling.

Further, a wireless device is provided, the wireless device comprising: a memory circuitry, a processor circuitry, and a wireless interface, wherein the wireless device is configured to perform any of the methods disclosed herein.

Advantageously, the wireless device and method disclosed herein benefit from an improved battery life, for example when considering low activity in the cell, e.g., at night time, or when one or multiple wireless devices require frequent retransmissions of the paging information, e.g., poor coverage. The disclosed wireless device reduces or avoids false-wake-up or overhearing energy cost as well as idle-channel listening energy cost, especially in multi-beam operation.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1A is a diagram illustrating an exemplary wireless communication system comprising an exemplary network node and an exemplary wireless device according to this disclosure,

FIG. 1B is a schematic diagram illustrating an exemplary DRX period and paging according to prior art,

FIG. 1C is a schematic diagram of an exemplary DRX period and paging according to one or more embodiments of the present disclosure,

FIG. 1D is a schematic diagram of an exemplary DRX period and paging according to one or more embodiments of the present disclosure,

FIG. 2 is a flow-chart illustrating an exemplary method, performed in a network node of a wireless communication system, for an enhanced paging of a wireless device of a set of wireless devices according to this disclosure,

FIG. 3 is a flow-chart illustrating an exemplary method, performed in a wireless device, for an enhanced paging of the wireless device according to this disclosure,

FIG. 4 is a block diagram illustrating an exemplary network node according to this disclosure, and

FIG. 5 is a block diagram illustrating an exemplary wireless device according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

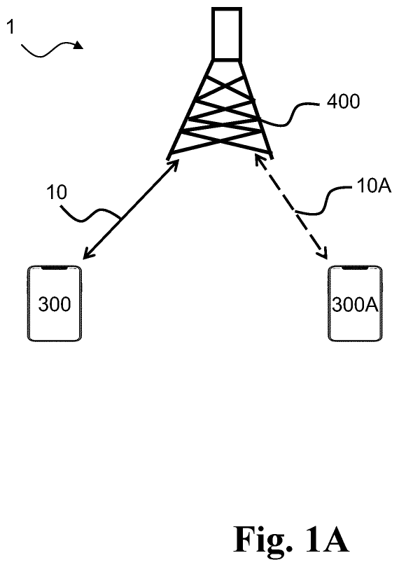

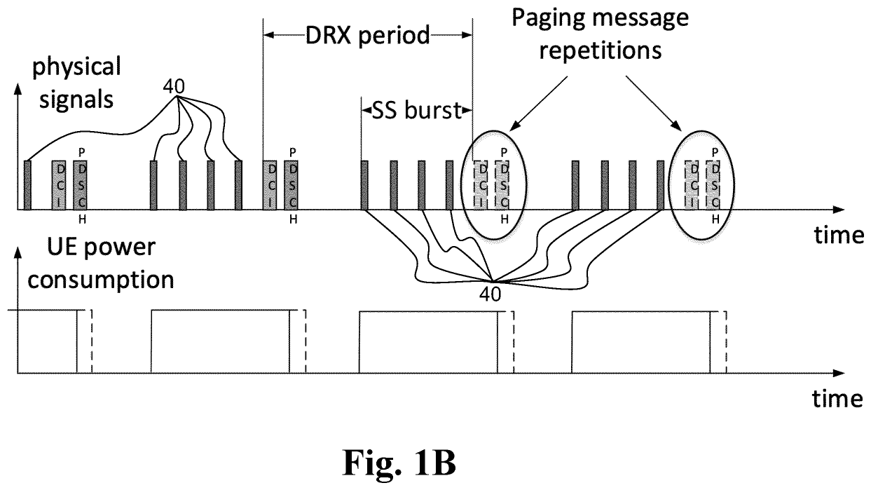

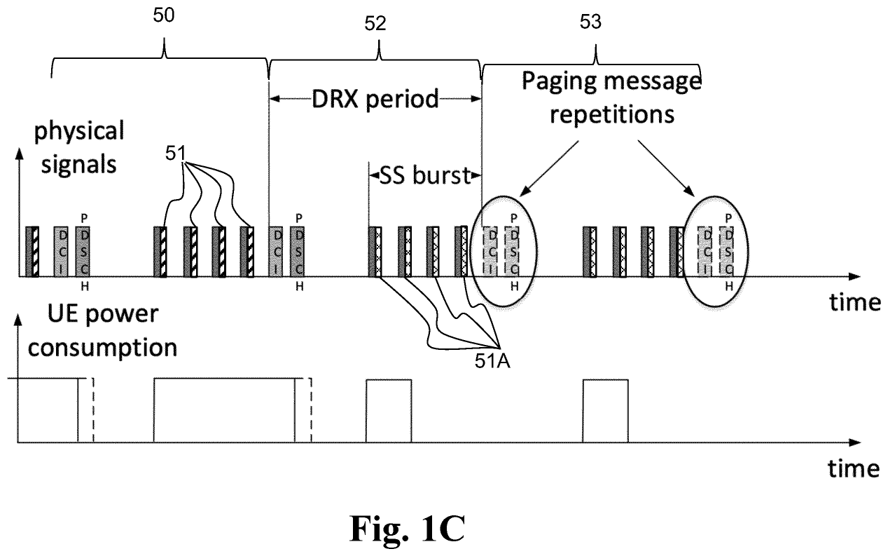

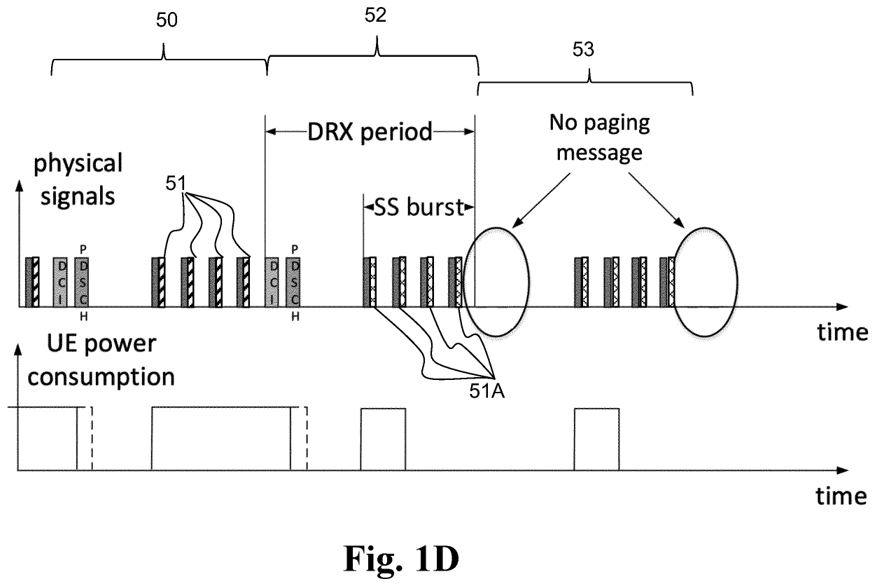

FIG. 1A is a diagram illustrating an exemplary wireless communication system 1 comprising an exemplary network node 400 and an exemplary wireless device 300 according to this disclosure.

As discussed in detail herein, the present disclosure relates to a wireless communication system 1 comprising a cellular system, e.g. a 3rd Generation Partnership Project, 3GPP, wireless communication system, e.g. with NR functionality in FR2. The wireless communication system 1 comprises a wireless device 300 and/or a network node 400.

A network node disclosed herein refers to a radio access network node operating in the radio access network, such as a base station, an evolved Node B, eNB, gNB.

The wireless communication system 1 described herein may comprise one or more wireless devices 300, 300A, and/or one or more network nodes 400, such as one or more of: a base station, an eNB, a gNB and/or an access point.

A wireless device may refer to a mobile device and/or a user equipment, UE.

The wireless device 300, 300A may be configured to communicate with the network node 400 via a wireless link (or radio access link) 10, 10A.

FIG. 1B is a schematic diagram of an exemplary DRX period and paging according to prior art.

As illustrated in FIG. 1B, during idle mode, the wireless device is requested to periodically monitor for paging information—at a rate referred to as DRX cycle. In New Radio, NR, Frequency Range FR2, the burden of monitoring paging is, however, dramatically increased compared with FR1 and Long Term Evolution, LTE. Indeed, the wireless device is, prior to reading the paging information, to establish which beam to use for reception, and which gNB transmit beam to listen to. In fact, the wireless device may not even be aware of which of its antenna arrays that should be used for reception; a typical DRX cycle is e.g. 2-3 seconds, but in future this can be as long as hours, and it is not unlikely that the wireless device has been rotated/moved, so that an entirely different antenna array is to be used compared with the one used during the most recent paging occasion.

In NR FR2, the wireless device is to wake up much earlier than the paging occasion (paging indicator (e.g. Downlink Control Information, DCI) and paging message on Physical Downlink Shared Channel, PDSCH) in order to establish a suitable beam to be used during the paging occasion. To establish the beam, the wireless device needs to listen to the synchronization signal block, SSB 40 of SSB bursts shown in FIG. 1B that precedes the paging occasion. The SSB 40 part of SSB bursts have for example periodicity of 20 ms, so an additional time awake of 100 ms is not unrealistic (to monitor all the wireless device's panels). The additional awake time of the wireless device as illustrated in FIG. 1B lower graph increases the power consumption of the wireless device. Hence, there is a need for reducing the additional awake time.

FIG. 1B shows a timeline (upper graph) showing physical signals received by a wireless device with discontinuous reception, DRX and the corresponding awake time (lower graph) illustrating the wireless device energy consumption according to prior art. For example, the wireless device wakes up in advance of each DRX period and selects a receive beam and gNB beam to listen to. To guarantee that it is possible to select a high-quality beam pair, the wireless device wakes up e.g. K′ physical signals, e.g. K′ synchronization signal bursts before the paging message (e.g. the paging message on Physical Downlink Shared Channel, PDSCH). For example, the value of K′ is typically set attending to e.g. a worst-case scenario depending, e.g., on the estimated mobility of the wireless device. However, the wireless device can normally find a suitable beam pair using less than K physical signals, e.g. K′ synchronization signal bursts. Yet because the wireless device does not know at this time whether paging message has been scheduled by the network node, the wireless device remains in active state, draining current and awaiting a potential paging message.

For sparse traffic situations, it is likely that there is no wireless device to be paged.

The present disclosure proposes to make, inter alia, e.g. this information available to the wireless devices as early as possible, via control signaling indicating a change in paging of an upcoming paging period, with respect to a previous paging period. More generally, assuming that a set of wireless devices are repeatedly paged (in cases where they cannot hear the paging), the present disclosure proposes a technique that enables informing the wireless devices that there is no change in paging information compared with the most recent paging occasion. In other words, for example, the same set of wireless devices is being paged for the same reasons, compared to the most recent paging occasion. This can lead to extra cost for those wireless devices that are listening to the same DRX-ON period as the ones which are repeatedly paged, but those wireless devices may not be paged.

FIG. 1C is a schematic diagram of an exemplary DRX period and paging including the control signalling indicating a change according to one or more embodiments of the present disclosure. FIG. 1C shows a timeline (upper graph) showing physical signals received by a wireless device with discontinuous reception, DRX and the corresponding awake time (lower graph) illustrating the wireless device power consumption according to one or more embodiments of the present disclosure.

FIG. 1C shows a first paging period 52. A paging period refers herein to a time period where one or more wireless devices may be paged by the network node. e.g. paging monitoring occasion, e.g. a paging occasion. A paging period may comprise one or more paging occasions. For example, a paging occasion involves the wireless device waking up according to UE identifier (e.g. UE ID) but only to read Paging Radio Network Temporary Identifier P-RNTI (repeated in all the beams) in physical downlink control channel, PDCCH, monitoring occasion.

A paging message includes the UE ID and is repeated on a plurality of beams, such as all beams.

FIG. 1C shows control signaling 51 indicating a change in paging of the first paging period 52, wherein the change in paging is with respect to a paging period preceding 50 the first paging period 52. For example, the control signaling 51 indicates that there is a change in the paging of the first paging period 52 with respect to the preceding paging period 50. For example, the control signaling 51 may be in form of an additional bit indicating whether paging information has changed compared to the most recent paging occasion (bit set to ‘1’) or not (bit set to ‘0’) has been added to the physical signals transmitted to the wireless device (e.g. K bursts preceding a paging occasion of the first paging period, and we have assumed K≥K′ so that the wireless device which finds a satisfactory beam still listens to the control signalling). For example, the wireless device only needs two SS bursts to select an appropriate beam pair. Note that when paging repetitions occur, the wireless device can immediately after the beam acquisition phase go into sleep mode until the next DRX period, thus reducing power consumption associated with PDCCH monitoring as illustrated in the lower graph of the FIG. 1C (because the paging information has not changed between the first paging period and the second paging period). In other words, FIG. 1C shows control signaling 51 and 51A via physical signals (e.g. SSB burst) so that a wireless device can determine at an early stage, i.e., after beam (re)acquisition, whether a paging message needs to be received, or whether the wireless device can immediately enter sleep mode.

FIGS. 1C-1D illustrate K=K′=1, i.e., only one burst per DRX period is shown, for the sake of simplicity.

FIG. 1C shows a second paging period 53 and control signaling 51A indicating a change in paging of the second paging period 53, wherein the change in paging is with respect to the first paging period 52 preceding the second paging period 53. For example, the control signaling 51A indicates that there is no change in the paging of the second paging period 53 with respect to the first paging period 52, as can be seen from the awake time where the wireless device is awake only for the physical signal(s), e.g. SSB burst and control signalling 51A and returns to a sleep mode. In one or more embodiments, the second paging period 53 may be directly succeeding to the first paging period 52. In other embodiments, the second paging period may not be directly succeeding to the first paging period.

FIG. 1D is a schematic diagram of an exemplary DRX period and paging including the control signalling 51, 51A indicating a change according to one or more embodiments of the present disclosure. FIG. 1D shows a timeline (upper graph) showing physical signals received by a wireless device with discontinuous reception, DRX and the corresponding awake time (lower graph) illustrating the wireless device power consumption according to one or more embodiments of the present disclosure.

FIG. 1D shows control signaling 51 indicating a change in paging of the first paging period 52, wherein the change in paging is with respect to a paging period preceding 50 the first paging period 52. For example, the control signaling 51 indicates that there is a change in the paging of the first paging period 52 with respect to the preceding paging period 50.

FIG. 1D shows a second paging period 53 and control signaling 51A indicating a change in paging of the second paging period 53, wherein the change in paging is with respect to the first paging period 52 preceding the second paging period 53. For example, the control signaling 51A indicates that there is no change in the paging of the second paging period 53 with respect to the first paging period 52, as can be seen from the awake time where the wireless device is awake only for the SS burst and control signalling 51A and returns to a sleep mode. In other words, there is no paging message in the second paging period for the wireless device.

FIG. 1D shows that the wireless device can save power during paging repetitions, but also during DRX periods for which no paging messages have been scheduled for transmission, i.e., an empty DRX period. In this case, a further optimization is possible: the additional bit of the K physical signals, e.g. K synchronization signal bursts preceding the first empty DRX period can be set to ‘0’, i.e., unchanged paging information, hence enabling the wireless devices in the set of wireless devices to enter sleep mode.

The control signaling 51, 51A via the physical signals repetition, e.g. physical signals burst, e.g. SS burst “repetition” can also be used to signal empty DRX periods, i.e., DRX periods without paging messages. In this case, a further optimization is possible, and the first empty DRX period can be also flagged as not containing a paging message.

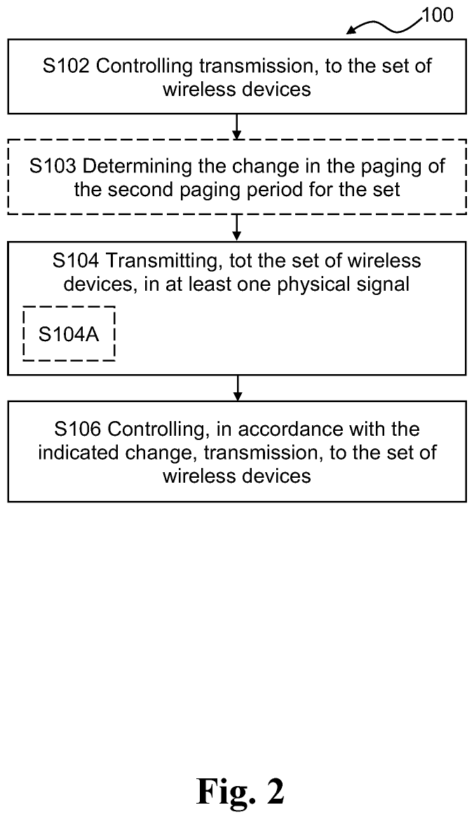

FIG. 2 shows a flow diagram of an exemplary method, performed by a network node, for an enhanced paging of a wireless device of a set of wireless devices. The set comprises one or more wireless devices. For example, the wireless device is in Idle mode, such radio resource control, RRC, Idle mode. In one or more example embodiments, the wireless device may be in connected mode.

The method 100 comprises controlling S102 transmission, to the set of wireless devices, of a first paging message in a first paging period. In one or more exemplary methods, controlling S102 transmission, to the set of wireless devices, of a first paging message in a first paging period comprises transmitting, to the set of wireless devices, the first paging message in the first paging period. In one or more exemplary methods, controlling S102 transmission, to the set of wireless devices, of a first paging message in a first paging period comprises refraining from transmitting, to the set of wireless devices, the first paging message in the first paging period.

A paging message (e.g. the first paging message and/or a second paging message) comprises one or more wireless device identifiers (e.g. UE ID) associated with the wireless devices that are paged. The paging message may be repeated on one or more beams, such as all the beams of the wireless device in multibeam operations.

A paging period may be seen as a time period where one or more wireless devices may be paged by the network node, e.g. paging monitoring occasion, e.g. a paging occasion. For example, a paging occasion involves the wireless device waking up according to UE ID but only to read P-RNTI (repeated in all the beams) on PDCCH monitoring occasion. In one or more example methods, the paging message includes the UE ID and is repeated on all the beams.

In one or more exemplary methods, the method 100 comprises determining S103 the change in the paging of the second paging period for the set with respect to the first paging period. For example, the change may be determined based on paging messages or lack thereof in the second paging period comparing to the first paging period.

The method 100 comprises transmitting S104, to the set of wireless devices, in at least one physical signal between the first paging period and a second paging period succeeding the first paging period, control signalling indicative of a change in paging of the second paging period. The change in paging is with respect to the first paging period (e.g. a previous paging period). Control signalling may be seen as control information. In other words the control signalling, such as the control information, is transmitted in the at least one physical signal. The control signalling indicative of the change in paging of the second paging period with respect to the first paging period may be seen as control signalling indicating whether there is a change in paging of the second paging period with respect to the first paging period. The control signalling indicative of the change in paging of the second paging period with respect to the first paging period may be seen as control signalling indicating whether there is a change in paging of the second paging period for the set of wireless devices with respect to the first paging period for the set of wireless devices. In other words, the paging (e.g. paging information) of the second paging period for the set of wireless devices is compared to the paging (e.g. paging information) of the first paging period for the set of wireless devices. The control signalling indicative of the change in paging of the second paging period with respect to the first paging period may be seen as control signalling indicating whether there is a change in paging of the second paging period for the set of wireless devices with respect to a previous paging period for the set of wireless devices. In one or more embodiments, the control signalling indicating whether there is a change in paging of the second paging period with respect to the first paging period comprises control signalling indicating that there is a change in paging of the second paging period with respect to the first paging period or control signalling indicating that there is no change in paging of the second paging period with respect to the first paging period. In other words, the control signaling indicating a change may be seen as indicative of a change state, and/or indicative of a change status and/or a change parameter.

In one or more embodiments, the control signalling indicative of the change comprises control signalling indicating a change, or indicating an absence of change. For example, the absence of change or a positive change may be signaled implicitly, e.g. by signaling one or the other. In other words, the change information indicating “change” or “no change” may be carried by the physical signal in an implicit manner or in an explicit manner.

The previous paging period may precede the first paging period. In one or more exemplary methods, the second paging period directly succeeds the first paging period.

In one or more example methods, the control signaling indicative of change may be implicitly signaled.

In one or more example methods, the control signaling indicative of change may be explicitly signaled. For example, the control signalling indicative of the change may be in form of a flag and/or one or more control messages. For example, the control signalling may comprise an additional bit added to the K SSB bursts preceding the upcoming paging occasions, said bit indicating whether the paging information has changed compared to the most recent occasion. As soon as a wireless device has been able to establish its beam, and provided that the wireless device was capable of reading the most recent paging information, the wireless device can resume idle mode if there is no change. In fact, the wireless device may not need to read the actual paging information. For example, the control signalling indicating the change may be in form of an additional bit in a synchronization signal burst include e.g. (i) modifying the primary and/or secondary synchronization signals, and/or (ii) including the additional bit as part of the Physical Broadcast Channel, PBCH.

For example, the control signalling indicating the change may be in form of multiple bits of information added in conjunction with the K synchronization signal burst preceding the paging frame, each bit addressing one paging occasion, or multiple bits jointly addressing several occasions.

In one or more exemplary methods, the physical signal comprises a synchronization signal and/or a reference signal. For example, the control signalling indicative of the change may be transmitted in a synchronization signal, (e.g. in SSB, e.g. in a SSB burst). For example, a synchronization signal, SS, Block is associated with a beam and a paging occasion. For example, a burst comprises a plurality of SS Blocks associated with the plurality of beams. For example, the control signalling indicative of the change may be transmitted in a sequence of symbols indicative of the change.

The method 100 comprises controlling S106, in accordance with the indicated change (e.g. in accordance with the transmitted control signalling indicative of change (e.g. of a change status, e.g. change or no change)), transmission, to the set of wireless devices, of a second paging message in the second paging period. In one or more exemplary methods, controlling S106, in accordance with the indicated change, transmission, to the set of wireless devices, of the second paging message in the second paging period comprises transmitting, to the set of wireless devices, in accordance with the indicated change (wherein the change indicates that a second paging message is to be transmitted while the first paging message was not transmitted), a second paging message in the second paging period. In one or more exemplary methods, controlling S106, in accordance with the indicated change, transmission, to the set of wireless devices, of the second paging message in the second paging period comprises refraining from transmitting, to the set of wireless devices, in accordance with the indicated change (wherein the change indicates that the second paging message is not to be transmitted while the first paging message was transmitted), a second paging message in the second paging period.

In one or more exemplary methods, the change in the paging of the second paging period for the set comprises a change in a second paging message of the second paging period with respect to the first paging period. For example, the change in the second paging message may be compared to any features of the first paging period (e.g. timing, e.g. a change in timing for a specific UE, e.g. a change in paging group).

In one or more exemplary methods, the change in the paging of the second paging period for the set comprises a change in a second paging message of the second paging period with respect to the first paging message for the set. For example, the change in the second paging message may be compared to the first paging message of the first paging period (e.g. the UE IDs are different in the second paging message compared to the first paging message).

In one or more exemplary methods, the change in the paging of the second paging period for the set comprises that the second paging period for the set does not include a transmission of the second paging message for the set while the first paging period has included a transmission of the first paging message.

In one or more exemplary methods, the change in the paging of the second paging period for the set comprises that the second paging period for the set includes a transmission of the second paging message for the set while the first paging period has not included a transmission of the first paging message.

In one or more exemplary methods, the transmission of the physical signal is repeated for a plurality of beams used to communicate between the network node and a wireless device of the set of wireless devices. The wireless device is configured to communicate using a plurality of beams.

In one or more exemplary methods, transmitting S104, to the set of wireless devices, in at least one physical signal between the first paging period and the second paging comprises transmitting S104A, to the set of wireless devices, in at least one physical signal in a time period before the second paging.

In one or more exemplary methods, the control signalling is further indicative of the time period, e.g. at initial connection. In one or more embodiments, the control signalling may be different than the control signalling indicating the change. For example, the method may comprise transmitting control signalling used to configure the number of beams. For example, the time period may be in form of K time slots, e.g. K synchronization signals, e.g. K SSBs. The network node may inform the wireless devices of the set about K at initial connection. In some examples. K may be 0, since for cells with heavy traffic, there is almost always updated paging information, and adding the control signalling indicating the change may lead to overhead.

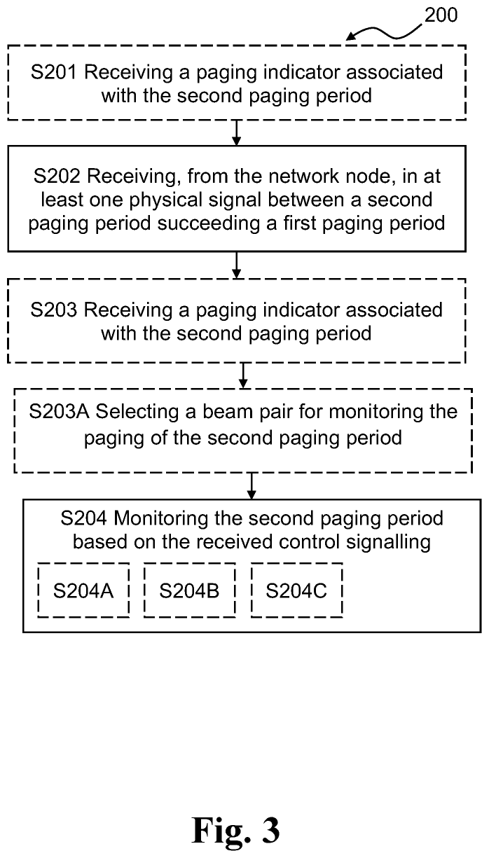

FIG. 3 shows a flow diagram of an exemplary method performed by a wireless device, for an enhanced paging of the wireless device, e.g. in idle mode. The wireless device may be part of a set of wireless devices, e.g. in a paging group.

The wireless device is in synchronization with the network node and has monitoring a first paging period.

The method 200 comprises receiving S202, from the network node, in at least one physical signal between a first paging period and a second paging period succeeding the first paging period, control signalling indicating a change in a paging of the second paging period. The change is with respect to the first paging period. For example, the control signalling indicative of the change in paging of the second paging period received in S202 may be transmitted in S104.

The method 200 comprises monitoring S204 the second paging period based on the received control signalling. In one or more exemplary methods, monitoring S204 the second paging period based on the received control signalling comprises upon determining that the control signalling indicates a change in the paging of the second paging period, monitoring S204A for a paging message in the second paging period, e.g. if Paging Frame Indicator, PFI is set.

In one or more exemplary methods, monitoring S204 the second paging period based on the received control signalling comprises upon determining that the control signalling does not indicate a change in the paging of the second paging period, forgoing S204B (e.g. refraining from) a monitoring of a paging message in the second paging period. For example, the wireless device may enter a power saving mode. The method 200 may comprise entering a power saving mode.

In one or more exemplary methods, the control signalling is further indicative of the time period.

In one or more exemplary methods, the method 200 comprises waking up in accordance with the time period. In one or more exemplary methods, the method 200 comprises selecting S203A a beam pair for monitoring the paging of the second paging period.

In one or more exemplary methods, the method 200 comprises receiving S203 a paging indicator associated with the second paging period. The paging indicator may comprise a DCI.

In one or more exemplary methods, the method 200 comprises upon determining that the control signalling does not indicate a change in the paging of the second paging period, forgoing S204B a monitoring of a paging message in the second paging period even if the paging indicator is received.

In one or more exemplary methods, the method 200 comprises receiving S201 a first paging message in the first paging period.

In one or more exemplary methods, the method 200 comprises monitoring S204 the second paging period based on the received control signalling comprises monitoring S204C the second paging period based on the received control signalling and in response to a successful receipt of the first paging message. For example, when the wireless device fails to decode the first paging message; irrespective of the control signalling indicating change in the paging, the wireless device attempts to receive a second paging message in the second paging period. In other words, the second paging period depends not only on the received control signalling, but also on successfully being in synchronization with the network node. Alternatively, if the UE fails to decode the first paging message, the network does not set the control signalling to “no change”. because the network node basically knows that the UE has not reacted to the message (since the UE has not entered random access channel, RACH).

For example, when the wireless device is not capable of reading the paging information at some time instant, the wireless device may disregard the control signalling indicating change in paging in the second paging period and may try to decode the paging. The control signalling is used by the wireless device when the wireless device has received a previous paging message.

For example, the control signalling at time N can only be used by the wireless device if the wireless device successfully decodes the paging message at a time M<N instant before, and then obtains control signalling indicative of change in paging at time T, M<T<N.

Stated differently, the wireless device may ignore the control signaling indicating the change in paging in the second paging period, for example, when the wireless device listens for the first time to an SSB burst in order to find a cell that it intends to camp on, or when the wireless device listens for paging for the first time.

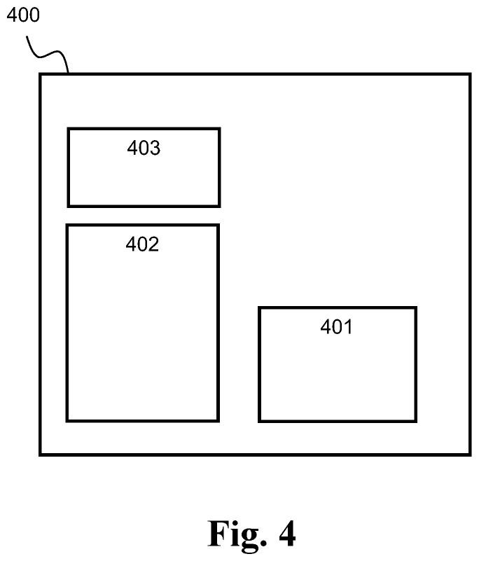

FIG. 4 shows a block diagram of an exemplary network node 400 according to the disclosure. The network node 400 comprises a memory circuitry 401, a processor circuitry 402, and a wireless interface 403. The network node 400 may be configured to perform any of the methods disclosed in FIG. 2. In other words, the network node 400 may be configured for an enhanced paging of a wireless device of a set of wireless devices.

The network node 400 is configured to communicate with a set of wireless devices, disclosed herein, using a wireless communication system.

The wireless interface 403 is configured for wireless communications via a wireless communication system, such as a 3GPP system, such as a 3GPP system supporting multibeam operations, such as NR FR2.

The network node 400 is configured to control, e.g. via the wireless interface 403 and the processor circuitry 402, transmission, to the set of wireless devices, of a first paging message in a first paging period.

The network node 400 is configured to transmit, e.g. via the wireless interface 403, to the set of wireless devices, in at least one physical signal between the first paging period and a second paging period succeeding the first paging period, control signaling indicating a change in paging of the second paging period. The change in paging is with respect to the first paging period.

The network node 400 is configured to control, e.g. via the wireless interface 403 and the processor circuitry 402, in accordance with the indicated change, transmission, to the set of wireless devices, of a second paging message in the second paging period.

The processor circuitry 402 is optionally configured to perform any of the operations disclosed in FIG. 2 (such as any one or more of S103, S104A). The operations of the network node 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the network node 400 may be considered a method that the network node 400 is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 4). The memory circuitry 401 is considered a non-transitory computer readable medium.

The memory circuitry 401 may be configured to store beam information and paging information in a part of the memory.

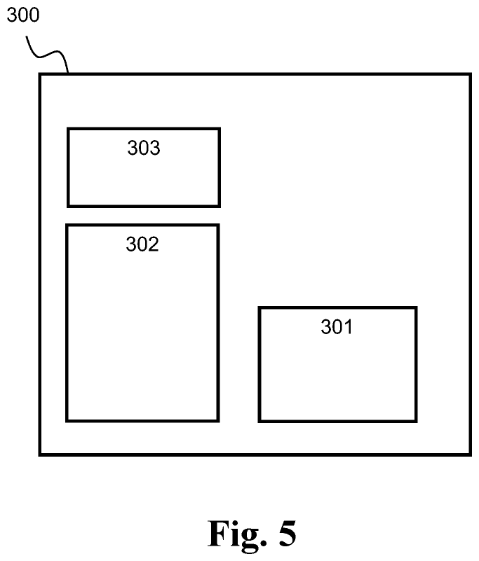

FIG. 5 shows a block diagram of an example wireless device 300 according to the disclosure. The wireless device 300 comprises a wireless interface 301, a processor circuitry 303, and a memory circuitry 302. The wireless interface 301 comprises an antenna or antenna panel. The wireless device 300 may be configured to perform any of the methods disclosed in FIG. 3.

The wireless device 300 is configured to communicate with a network node, such as network node 400 disclosed herein, using a wireless communication system (as illustrated in FIG. 1A). The wireless interface 301 is configured to communicate with the network node via a wireless communication system, such as a 3GPP system, e.g. supporting NR FR2.

The wireless device 300 is configured to, via the wireless interface 301, receive, from the network node, in at least one physical signal between a first paging period and a second paging period succeeding the first paging period, control signalling indicating a change in a paging of the second paging period. The change is with respect to the first paging period.

The wireless device 300 is configured to, via the processor circuitry 303 and the wireless interface 301, monitor the second paging period based on the received control signalling.

The processor circuitry 303 is optionally configured to perform any of the operations disclosed in FIG. 3, such as any one or more of S201, S203, S204A, S204B, S204C, S203A. The operations of the wireless device 300 may be embodied in the form of executable logic routines (e.g., lines of code, software programs, etc.) that are stored on a non-transitory computer readable medium (e.g., the memory circuitry 302) and are executed by the processor circuitry 303.

Furthermore, the operations of the wireless device 300 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuitry 302 may be one or more of a buffer, a flash memory, a hard drive, a removable media, a volatile memory, a non-volatile memory, a random access memory (RAM), or other suitable device. In a typical arrangement, the memory circuitry 302 may include a non-volatile memory for long term data storage and a volatile memory that functions as system memory for the processor circuitry 303. The memory circuitry 302 may exchange data with the processor circuitry 304 over a data bus. Control lines and an address bus between the memory circuitry 302 and the processor circuitry 303 also may be present (not shown in FIG. 3). The memory circuitry 302 is considered a non-transitory computer readable medium.

Embodiments of methods and products (network node and wireless device) according to the disclosure are set out in the following items:
Item 1. A method, performed by a network node, for an enhanced paging of a wireless device of a set of wireless devices, the method comprising:
   controlling (S102) transmission, to the set of wireless devices, of a first paging message in a first paging period,
   transmitting (S104), to the set of wireless devices, in at least one physical signal between the first paging period and a second paging period succeeding the first paging period, control signalling indicative of a change in paging of the second paging period, wherein the change in paging is with respect to the first paging period, and
   controlling (S106), in accordance with the indicated change, transmission, to the set of wireless devices, of a second paging message in the second paging period.
Item 2. The method according to item 1, wherein the change in the paging of the second paging period for the set comprises a change in a second paging message of the second paging period with respect to the first paging period.
Item 3. The method according to any of items 1-2, wherein the change in the paging of the second paging period for the set comprises a change in a second paging message of the second paging period with respect to the first paging message for the set.
Item 4. The method according to any of items 1-3, wherein the change in the paging of the second paging period for the set comprises that the second paging period for the set does not include a transmission of the second paging message for the set while the first paging period has included a transmission of the first paging message.
Item 5. The method according to any of items 1-3, wherein the change in the paging of the second paging period for the set comprises that the second paging period for the set includes a transmission of the second paging message for the set while the first paging period has not included a transmission of the first paging message.
Item 6. The method according to any of the previous items, wherein the transmission of the physical signal is repeated for a plurality of beams used to communicate between the network node and a wireless device of the set of wireless devices.
Item 7. The method according to any of the previous items, wherein transmitting (S104), to the set of wireless devices, in at least one physical signal between the first paging period and the second paging comprises transmitting (S104A), to the set of wireless devices, in at least one physical signal in a time period before the second paging.
Item 8. The method according to item 7, wherein the control signalling is further indicative of the time period.
Item 9. The method according to any of the previous items, wherein the second paging period directly succeeds the first paging period.
Item 10. The method according to any of the previous items, the method comprising:
   determining (S103) the change in the paging of the second paging period for the set with respect to the first paging period.
Item 11. The method according to any of the previous items, wherein the physical signal comprises a synchronization signal and/or a reference signal.
Item 12. A method, performed by a wireless device, for an enhanced paging of the wireless device in idle mode, the method comprising:
   receiving (S202), from the network node, in at least one physical signal between a first paging period and a second paging period succeeding the first paging period, control signalling indicative of a change in a paging of the second paging period, wherein the change is with respect to the first paging period; and
   monitoring (S204) the second paging period based on the received control signalling.
Item 13. The method according to item 12, wherein monitoring (S204) the second paging period based on the received control signalling comprises:
   upon determining that the control signalling indicates a change in the paging of the second paging period, monitoring (S204A) for a paging message in the second paging period.
Item 14. The method according to any of items 12-13, wherein monitoring (S204) the second paging period based on the received control signalling comprises:
   upon determining that the control signalling does not indicate a change in the paging of the second paging period, forgoing (S204B) a monitoring of a paging message in the second paging period.
Item 15. The method according to any of items 12-14, wherein the control signalling is further indicative of the time period.
Item 16. The method according to any of items 12-15, the method comprising selecting (S203A) a beam pair for monitoring the paging of the second paging period.
Item 17. The method according to any of items 12-16, the method comprising:
   receiving (S203) a paging indicator associated with the second paging period, and
   upon determining that the control signalling does not indicate a change in the paging of the second paging period, forgoing (S204B) a monitoring of a paging message in the second paging period even if the paging indicator is received.
Item 18. The method according to any of items 12-17, wherein the method comprises:
   receiving (S201) a first paging message in the first paging period, and
   monitoring (S204) the second paging period based on the received control signalling comprises monitoring (S204C) the second paging period based on the received control signalling and in response to a successful receipt of the first paging message.
Item 19. A network node comprising a memory circuitry, a processor circuitry, and a wireless interface, wherein the network node is configured to perform any of the methods according to any of items 1-11.
Item 20. A wireless device comprising a memory circuitry, a processor circuitry, and a wireless interface, wherein the wireless device is configured to perform any of the methods according to any of items 12-18.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1A-5 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method, performed by a network node, for an enhanced paging of a wireless device of a set of wireless devices, the method comprising:
controlling transmission, to the set of wireless devices, of a first paging message in a first paging period,
transmitting, to the set of wireless devices, in at least one physical signal between the first paging period and a second paging period succeeding the first paging period, control signalling indicative of a change in paging of the second paging period, wherein the change in paging is with respect to the first paging period, and
controlling, in accordance with the indicated change, transmission, to the set of wireless devices, of a second paging message in the second paging period.

2. The method according to claim 1, wherein the change in the paging of the second paging period for the set comprises a change in a second paging message of the second paging period with respect to the first paging period.

3. The method according to claim 1, wherein the change in the paging of the second paging period for the set comprises a change in a second paging message of the second paging period with respect to the first paging message for the set.

4. The method according to claim 1, wherein the change in the paging of the second paging period for the set comprises that the second paging period for the set does not include a transmission of the second paging message for the set while the first paging period has included a transmission of the first paging message.

5. The method according to claim 1, wherein the change in the paging of the second paging period for the set comprises that the second paging period for the set includes a transmission of the second paging message for the set while the first paging period has not included a transmission of the first paging message.

6. The method according to claim 1, wherein the transmission of the physical signal is repeated for a plurality of beams used to communicate between the network node and a wireless device of the set of wireless devices.

7. The method according to claim 1, wherein transmitting, to the set of wireless devices, in at least one physical signal between the first paging period and the second paging comprises transmitting, to the set of wireless devices, in at least one physical signal in a time period before the second paging.

8. The method according to claim 7, wherein the control signalling is further indicative of the time period.

9. The method according to claim 1, wherein the second paging period directly succeeds the first paging period.

10. The method according to claim 1, the method comprising:
determining the change in the paging of the second paging period for the set with respect to the first paging period.

11. The method according to claim 1, wherein the physical signal comprises a synchronization signal and/or a reference signal.

12. A method, performed by a wireless device, for an enhanced paging of the wireless device in idle mode, the method comprising:
receiving, from the network node, in at least one physical signal between a first paging period and a second paging period succeeding the first paging period, control signalling indicating a change in a paging of the second paging period, wherein the change is with respect to the first paging period; and
monitoring the second paging period based on the received control signalling.

13. The method according to claim 12, wherein monitoring the second paging period based on the received control signalling comprises:
upon determining that the control signalling indicates a change in the paging of the second paging period, monitoring for a paging message in the second paging period.

14. The method according to claim 12, wherein monitoring the second paging period based on the received control signalling comprises:
upon determining that the control signalling does not indicate a change in the paging of the second paging period, forgoing a monitoring of a paging message in the second paging period.

15. The method according to claim 12, wherein the control signalling is further indicative of the time period.

16. The method according to claim 12, the method comprising selecting a beam pair for monitoring the paging of the second paging period.

17. The method according to claim 12, the method comprising:
receiving a paging indicator associated with the second paging period, and
upon determining that the control signalling does not indicate a change in the paging of the second paging period, forgoing a monitoring of a paging message in the second paging period even if the paging indicator is received.

18. The method according to claim 12, wherein the method comprises:
receiving a first paging message in the first paging period, and
monitoring the second paging period based on the received control signalling comprises monitoring the second paging period based on the received control signalling and in response to a successful receipt of the first paging message.

19. A network node comprising a memory circuitry, a processor circuitry, and a wireless interface, wherein the network node is configured to perform the method according to claim 1.

20. A wireless device comprising a memory circuitry, a processor circuitry, and a wireless interface, wherein the wireless device is configured to perform the method according to claim 12.
